(19) United States
(12) Patent Application Publication
(10) Pub. No.: US 2024/0139983 A1
(43) Pub. Date: May 2, 2024

(54) ROTARY CUTTING UNIT

(71) Applicant: Hyperion Materials & Technologies, Inc., Worthington, Ohio, OH (US)

(72) Inventors: Motoki Sugiura, Kobe, Hyogo (JP); Jordan Gachet, Revel-Tourdan (FR)

(21) Appl. No.: 18/279,107

(22) PCT Filed: Feb. 16, 2022
(86) PCT No.: PCT/US2022/016520

§ 371 Date: Aug. 28, 2023

Related U.S. Application Data
(60) Provisional application No. 63/160,162, filed on Mar. 12, 2021.

(30) Foreign Application Priority Data
Mar. 8, 2021 (FR) FR2102204

(51) Int. Cl. B26D 1/62; B26D 7/26; B26F 1/38

(52) U.S. Cl. CPC B26D 1/626; B26D 7/265; B26F 1/384

(57) ABSTRACT

Provided is a rotary cutting unit including (i) a frame, (ii) a rotary cutter including a rotary cutting drum having a rotary cutting surface with a first axis of rotation. At least one knife member is anchored on the rotary cutting surface. The rotary cutting unit further includes (iii) an anvil including an anvil portion having an anvil surface configured to directly contact the at least one knife member with a second axis of rotation. Further provided is a rotary cutting system including a plurality of rotary cutting units.

### FIELD OF THE DISCLOSURE

The present disclosure relates to a rotary cutting unit comprising a rotary cutter and a rotatable anvil. More particularly, the disclosure relates to a rotary cutting unit for rotary die cutting by rolls with a load bearing structure on one side and an open frame.

### BACKGROUND

In the discussion that follows, reference is made to certain structures and/or methods. However, the following references should under no circumstances be construed as an admission that these structures and/or methods constitute prior art. Applicant expressly reserves the right to demonstrate that such structures and/or methods do not qualify as prior art against the present subject matter.

An exemplary rotary cutting unit is known from U.S. Pat. No. 6,244,148 and comprises a rotary cutter in a working relationship with a rotary anvil. The rotary cutter is provided with a substantially circular-cylindrical body having a cylindrical cutting surface and at least one knife member protruding from the surface. The radially protruding peripheral part of the knife member has a diameter larger than that of the surface. Each side of the rotary cutter is provided with an axle supported in bearings. Between the axles and the surface, i.e. on each side of the surface, a pair of annular abutment members are provided. The abutment members have a diameter larger than that of the surface to allow abutment against a pair of load-receiving portions of the anvil.

The anvil is provided with an anvil portion and the pair of load-receiving portions. The anvil portion is adapted to cooperate with the knife member of the rotary cutting drum, whereas the load-receiving portions are configured to abut the abutment members of the rotary cutter. The anvil is supported in bearings outside the anvil portion and outside the load-bearing portions, as seen in the axial extension of the anvil.

Further, the abutment members have a diameter, which is substantially the same as the radially protruding peripheral part of the knife member. The abutment members are adapted to lie against and transmit load, such that a predetermined pressure is exerted on the load-receiving portions of the anvil to achieve a desired cutting property. Optionally, the abutment may also transmit rotation of the rotary cutter drum to the anvil surface, such that it turns in a direction opposite to that of the rotary cutter.

A product is cut from a web introduced between the drums by the centrally arranged knife member.

Another example of a cutting unit is known from U.S. Pat. No. 7,942,088. In the related art rotary cutting unit of U.S. Pat. No. 7,942,088, a rotary cutter is provided with a substantially circular-cylindrical hollow or solid body having a cylindrical surface and at least one knife member protruding from the surface. The radially extending peripheral part of the knife member has a diameter larger than that of the surface. The rotary cutter is arranged on or is an integral part of an arbor extending axially from each side of the rotary cutter and being supported in bearings. Axially on each side of the surface, a pair of annular abutment members are provided. The abutment members have a diameter larger than that of the surface to allow abutment against an anvil.

The anvil includes an axle, an anvil portion and a pair of load-transmitting portions. The anvil portion is adapted to cooperate with the knife member of the rotary cutter, whereas the load-transmitting portions are adapted to abut the abutment surfaces of the rotary cutter. Moreover, the abutment members have a diameter, which is substantially the same as the radially peripheral part of the knife member.

Axially on each side of the anvil portion, the axle is rotatably arranged in bearings, each surrounded by a non-rotary load-receiving member. The load-receiving members are arranged axially inside the load-transmitting portions, i.e., each load-receiving portion is located axially between the anvil portion and each load-transmitting portion.

An upward load is applied by a pair of pneumatic cylinders to the load-receiving members. The load is transmitted further via the load-transmitting portions to the abutment members. The upward load is transmitted via the load-transmitting portions to the abutment members. The total upward load is greater than the weight of the anvil and sufficient to cause the anvil to be bent towards the rotary cutter. This results in the cutting properties being improved especially in the axially central portions of the knife members. The load causes a counter directed force at the surface 8, which is transmitted to the bearings to produce force. The load causes the anvil to be bent slightly upwards. The load applied by the pair of pneumatic cylinders is adjusted by performing a cutting operation and checking the cutting result. If the cutting result is not as desired, the pressure is increased or decreased, until the cut is uniform over the whole extension of the rotary cutter and the anvil.

The optimal cut is achieved when the anvil is straight, i.e. when the line is straight, since the abutment members and the knife members protrude substantially to the same extent above the surface and will have constant cutting properties along the whole anvil portion.

For example, in current rotary cutting units, a width of a material that can be fed into the rotary cutting unit is limited by the separation distance (i.e. in the longitudinal direction along corresponding to the longitudinal orientation of the axes of rotation) between structures on either side of the rotary cutter and the anvil. The structures form a closed side on both sides of the rotary cutter and the anvil. However, by supporting the rotary cutter and/or supporting the anvil on one side, an open-sided arrangement is formed, and a material wider than the rotary cutter and the anvil can be fed through the rotary cutting unit. For example, a first width portion of a material, such as a non-woven material can be fed through the rotary cutting unit between the rotary cutter and the anvil to be acted upon by the knife member to cut the non-woven material. A second width portion of the non-woven material can extend through the open-sided arrangement, e.g., may overhang outside the envelope of the rotary cutter and the anvil.

In view of the foregoing, there is a need for a rotary cutting unit and a rotary cutting system including a plurality of rotary cutting units, which obviate one or more of the mentioned limitations and disadvantages of the art in the field of rotary cutting units.

### SUMMARY

A first object of the present disclosure is to provide a rotary cutting unit including a frame and a rotary cutter. The rotary cutter includes a rotary cutting drum having a rotary cutting surface with a first axis of rotation. A first axle is located coincident to the first axis of rotation. A first load bearing structure is located on only one of a first end and a second end of the rotary cutting drum. At least one knife member is located on the rotary cutting surface. The rotary cutter unit further includes an anvil including an anvil portion having an anvil surface configured to directly contact the at least one knife member with a second axis of rotation. A second axle is located coincident to the second axis of rotation. A second load bearing structure is located on only one of a first end and a second end of the anvil portion. The rotary cutting unit further includes a first plurality of bearings supporting the first axle for rotation about the first axis of rotation. Moreover, the rotary cutting unit includes a second plurality of bearings supporting the second axle for rotation about the second axis of rotation. A surface of the first load bearing structure contacts a surface of the second load bearing structure.

Optionally, along the first axis of rotation, a first portion of the first axle is on one side of the rotary cutting drum, and a second portion of the first axle is on a second side of the rotary cutting drum.

Optionally, the first plurality of bearings comprises two rotary cutter bearings including a first rotary cutter bearing configured to support the first portion of the first axle for rotation about the first axis of rotation, and a second rotary cutter bearing configured to support the second portion of the first axle for rotation about the first axis.

Optionally, along the second axis of rotation, the second axle is on one side of the anvil portion, and the second load bearing structure is spaced apart from anvil portion.

Optionally, the second plurality of bearings includes two anvil bearings, each configured to support the second axle for rotation about the second axis. Along the second axis of rotation, a first of the two anvil bearings is between the second load bearing structure and the anvil portion, and the second load bearing structure is between the first of the two anvil bearings and a second of the two anvil bearings.

Optionally, the rotary cutter is coupled to a motor to be driven in rotation about the first axis of rotation.

Optionally, only the first axle, among the first and second axles, is directly supported by the frame.

Optionally, the anvil is coupled to a motor to be driven in rotation about the second axis of rotation.

Optionally, only the second axle, among the first and second axles, is directly supported by the frame.

Optionally, along the first axis of rotation, the first axle is on one side of the rotary cutting drum, and the first load bearing structure is spaced apart from the rotary cutting drum.

Optionally, the first plurality of bearings includes two rotary cutter bearings, each configured to support the first axle for rotation about the first axis. Along the first axis of rotation, a first of the two rotary cutter bearings is between the first load bearing structure and the rotary cutting drum, and the first load bearing structure is between the first of the two rotary cutter bearings and a second of the two rotary cutter bearings.

Optionally, along the second axis of rotation, a first portion of the second axle is on one side of the anvil portion, and a second portion of the second axle is on a second side of the anvil portion.

Optionally, the second plurality of bearings comprises two anvil bearings including a first anvil bearing configured to support the first portion of the second axle for rotation about the second axis of rotation, and a second anvil bearing configured to support the second portion of the second axle for rotation about the second axis.

Optionally, a first pneumatic cylinder is configured to apply a first load to the first plurality of bearings.

Optionally, a first pneumatic cylinder is configured to apply a first load to the second plurality of bearings.

Optionally, a second pneumatic cylinder is configured to apply a second load to the first plurality of bearings.

Optionally, the rotary cutter is coupled to a motor to be driven in rotation about the first axis of rotation.

Optionally, only the first axle, among the first and second axles, is directly supported by the frame.

Optionally, the anvil is coupled to a motor to be driven in rotation about the second axis of rotation.

Optionally, only the second axle, among the first and second axles, is directly supported by the frame.

Optionally, the rotary cutter is horizontally above the anvil.

Optionally, the anvil is horizontally above the rotary cutter.

Optionally, the first load bearing structure is at a far side of the rotary cutting drum.

Optionally, the first load bearing structure is off-center of the rotary cutting drum.

Optionally, the first load bearing structure comprises a plurality of adjacent load-bearing substructures.

Optionally, a bending effect is applied to one of the rotary cutter or the anvil.

A second object of the present disclosure is to provide a rotary cutting system comprising a plurality of rotary cutting units.

Optionally, a first rotary cutting unit of the plurality of rotary cutting units is positioned relative to a second rotary cutting unit of the plurality of rotary cutting units, such that the first axle of the rotary cutter of the first rotary cutting unit is co-axial to the first axle of the rotary cutter of the second rotary cutting unit.

Optionally, the first axle of the rotary cutter of the first rotary cutting unit being co-axial to the first axle of the rotary cutter of the second rotary cutting unit, forms an integrated axle across the first rotary cutting unit and the second rotary cutting unit.

Optionally, an integrated anvil has a continuous anvil surface rotating relative to a single axis of rotation.

Optionally, an integrated anvil has a discontinuous anvil surface rotating relative to a single axis of rotation, the discontinuous anvil surface comprising a first anvil surface associated with the rotary cutter of the first rotary cutting unit, and a second anvil surface associated with the rotary cutter of the second rotary cutting unit.

Optionally, a distance separating the first rotary cutting unit from the second rotary cutting unit is adjustable by sliding.

Optionally, the anvil of the first rotary cutting unit is integrated with the anvil of the second rotary cutting unit.

Optionally, the rotary cutter of each of the first rotary cutting unit and the second rotary cutting unit is fixed to the frame of its respective rotary cutting unit.

Optionally, the rotary cutter of each of the first rotary cutting unit and the second rotary cutting unit is attached to a respective rail on each respective frame of its rotary cutting unit, such that a distance separating the first rotary cutting unit from the second rotary cutting unit is adjustable by sliding.

Other systems, methods, features and advantages will be, or will become apparent to one with skill in the art upon examination of the following figures and detailed description. It is intended that all such additional systems, methods, features and advantages be included within this description, be within the scope of the present disclosure, and be protected by the following claims. Nothing in this section should be taken as a limitation on those claims. Further aspects and advantages are discussed below in conjunction with the embodiments of the disclosure. It is to be understood that both the foregoing general description and the following detailed description of the present disclosure are examples and explanatory and are intended to provide further explanation of the disclosure as claimed.

### BRIEF DESCRIPTION OF THE DRAWINGS

The accompanying drawings, which are included to provide a further understanding of the subject matter and are incorporated in and constitute a part of this specification, illustrate implementations of the subject matter and together with the description serve to explain the principles of the disclosure.

FIG. 1A is a side view of a rotary cutting unit in accordance with an exemplary embodiment of the subject matter.

FIG. 1B is a side view of a rotary cutting unit in accordance with an exemplary embodiment of the subject matter.

FIG. 1C is a side view of a rotary cutting unit in accordance with an exemplary embodiment of the subject matter.

FIG. 2A is a side view of a rotary cutting unit in accordance with an exemplary embodiment of the subject matter.

FIG. 2B is a side view of a rotary cutting unit in accordance with an exemplary embodiment of the subject matter.

FIG. 3A is a side view of a rotary cutting unit in accordance with an exemplary embodiment of the subject matter.

FIG. 3B is a side view of a rotary cutting unit in accordance with an exemplary embodiment of the subject matter.

FIG. 3C is a side view of a rotary cutting unit in accordance with an exemplary embodiment of the subject matter.

FIG. 3D is a side view of a rotary cutting unit in accordance with an exemplary embodiment of the subject matter.

FIG. 4A is a side view of a rotary cutting unit in accordance with an exemplary embodiment of the subject matter.

FIG. 4B is a side view of a rotary cutting unit in accordance with an exemplary embodiment of the subject matter.

FIG. 5A is a side view of a rotary cutting unit in accordance with an exemplary embodiment of the subject matter.

FIG. 5B is a side view of a rotary cutting unit in accordance with an exemplary embodiment of the subject matter.

FIG. 6 is a side view of a rotary cutting unit in accordance with an exemplary embodiment of the subject matter.

FIG. 7A is a side view of a rotary cutting system in accordance with an exemplary embodiment of the subject matter.

FIG. 7B is a side view of a rotary cutting system in accordance with an exemplary embodiment of the subject matter.

FIG. 7C is a side view of a rotary cutting system in accordance with an exemplary embodiment of the subject matter.

FIG. 8 is a side view of a rotary cutting system in accordance with an exemplary embodiment of the subject matter.

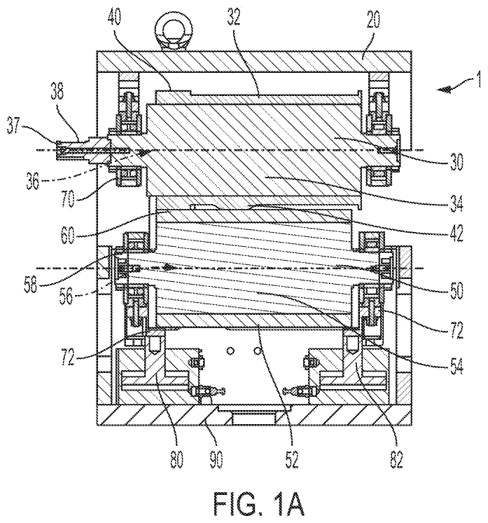

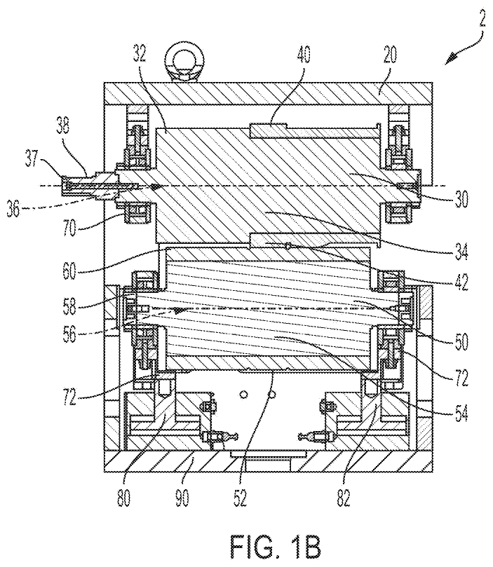

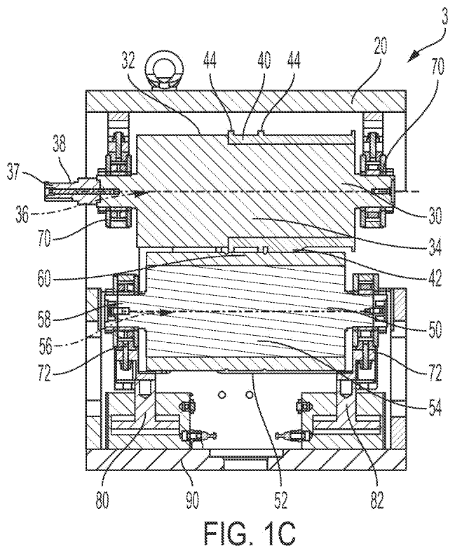

The side views in FIGS. 1A to 8 are in the feed-direction looking along the direction the material runs through the rotary cutting unit or system, and which, in the various views, is perpendicular to the axes of rotation of the rotary cutter and the anvil.

For ease of viewing, in some instances only some of the named features in the figures are labeled with reference numerals. Throughout the drawings and the detailed description, unless otherwise described, the same drawing reference numerals should be understood to refer to the same elements, features, and structures. The relative size and depiction of these elements may be adjusted for clarity, illustration, and convenience.

### DETAILED DESCRIPTION

Unless defined otherwise all technical and scientific terms used herein have the same meaning as commonly understood to one of ordinary skill in the art to which the presently described subject matter pertains.

Where a range of values is provided, for example, concentration ranges, percentage ranges, or ratio ranges, it is understood that each intervening value, to the tenth of the unit of the lower limit, unless the context clearly dictates otherwise, between the upper and lower limit of that range and any other stated or intervening value in that stated range, is encompassed within the described subject matter. The upper and lower limits of these smaller ranges may independently be included in the smaller ranges, and such embodiments are also encompassed within the described subject matter, subject to any specifically excluded limit in the stated range. Where the stated range includes one or both of the limits, ranges excluding either or both of those included limits are also included in the described subject matter.

The following definitions set forth the parameters of the described subject matter.

As used herein this disclosure, the terms “about” and “approximately” are used interchangeably. It is meant to mean plus or minus 1% of the numerical value of the number with which it is being used in the claims and herein this disclosure. Thus, “about” and “approximately” are used to provide flexibility to a numerical range endpoint by providing that a given value may be “above” or “below” the given value. As such, for example a value of 50% is intended to encompass a range defined by 49.5%-50.5%.

As used herein this disclosure, the term “predominantly” is meant to encompass at least 95% of a given entity in the claims, and equally of a feature described herein this disclosure.

Wherever used throughout the disclosure, the term “generally” has the meaning of “approximately”, “typically” or “closely” or “within the vicinity or range of”.

As used herein this disclosure, the term “substantial” or “substantially” refers to the complete or nearly complete extent or degree of an action, characteristic, property, state, structure, item, or result.

As used herein this disclosure, the term “anvil” refers to a hard structure with a flattened top surface, which may for example be molded into a rotary cutting unit disclosed herein to be in a working relationship with a rotary cutter. The anvil can be constructed from any suitable size. The anvil can be made of a suitable material or materials, such as the following but without limitation, steel, ceramic, bronze, copper, another suitable metal or a metallic alloy, or any desired combination thereof conferring a substantial hardness.

As used herein this disclosure, the term “bearing” refers to a physical element that constrains a relative motion to only a desired motion type, and further that reduces friction between moving parts. The unique design of the bearing determines the particular type of movement conveyed to a moving part. The specific design of the bearing may, for instance, facilitate a free linear movement of the moving part, or may equally impart a free rotation around a fixed axis. Alternatively, it may prevent, suppress, or otherwise inhibit a motion by specifically controlling the vectors of normal loads and forces that physically act on the moving parts. Bearings facilitate the desired motion by minimizing the effect of friction. Thus, bearings are classified exclusively according to the particular type of operation, the specific motion types that are allowed, or to the particular directions of the loads and forces that are applied to the moving parts.

As used herein this disclosure, the term, “axle” refers to a rotating bar on which, for example a wheel, a pair of wheels, or another rotating part can be attached or affixed.

As used herein this disclosure, the term, “pneumatic cylinder” refers to a mechanical device, which typically uses the power of a compressed gas to produce a force to result in a reciprocating (i.e. repeating backward and forward motion) linear motion. Once actuated, the compressed gas (i.e. typically compressed air) enters into the tube at one end of the piston, and thereafter imparts a force on the piston. Consequently, in effect the piston becomes displaced. Much like hydraulic cylinders, the compressed gas forces the piston in pneumatic cylinders to move in the desired direction. The piston is principally a disc or a cylinder. The piston rod transfers the force it develops, by the action of the power of the compressed gas, to the object that is desired to be moved.

As used herein this disclosure, the term “motor” refers to a mechanical or an electrical device that creates a motion.

As used herein this disclosure, the term “knife member” refers to for example a knife, a dagger, a dirk, or in essence to any material with substantially a sharp blade capable of cutting a material that is applied to the rotary cutting unit to process the applied material.

As used herein this disclosure, the term “rotary cutting unit” refers to a rotary cutting and a processing entity including (i) a frame, (ii) a rotary cutter including a rotary cutting drum having a rotary cutting surface with a first axis of rotation. At least one knife member is anchored on the rotary cutting surface. The rotary cutting unit further includes (iii) an anvil including an anvil portion having an anvil surface configured to directly contact the at least one knife member with a second axis of rotation.

As used herein this disclosure, the term “rotary cutting system” includes a plurality of the aforementioned rotary cutting units.

FIG. 1A through FIG. 6 are each a side view of a rotary cutting unit in accordance with various exemplary embodiments.

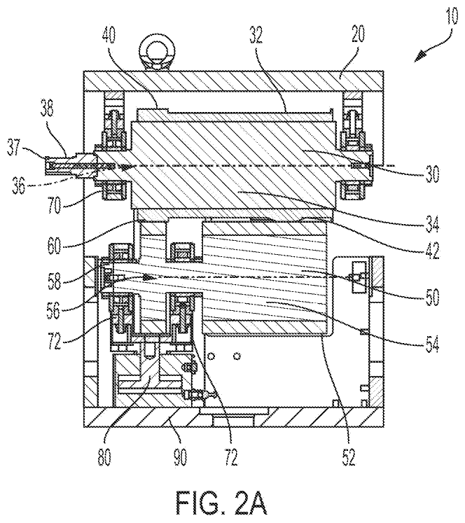

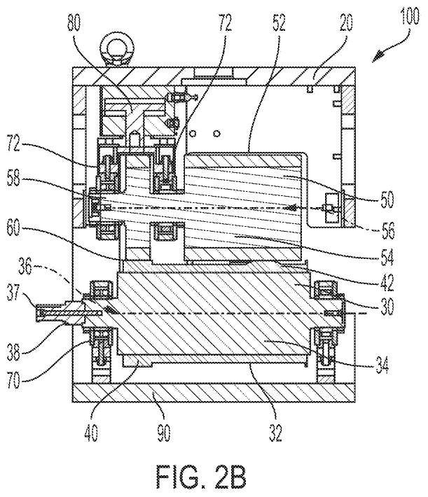

With reference to FIGS. 1A-2B, a rotary cutting unit (e.g., rotary cutting unit 1 in FIG. 1A, rotary cutting unit 2 in FIG. 1B, rotary cutting unit 3 in FIG. 1C, rotary cutting unit 10 in FIG. 2A and rotary cutting unit 100 in FIG. 25) includes a frame 20, a rotary cutter 30, and an anvil 50. The rotary cutter 30 includes a rotary cutting drum 32 having a rotary cutting surface 34 and a first axis of rotation 36, a first axle 38 located coincident to the first axis of rotation, a first load bearing structure 40 (see FIG. 1A) located on only one of a first end and a second end of the rotary cutting drum 32, and at least one knife member 42 located on the rotary cutting surface 34. In some embodiments, the first load bearing structure 40 may be positioned at a far side of the rotary cutting drum 32 as in FIG. 1A. In other embodiments, rather than being at a far side of the rotary cutting drum 32, the first load bearing structure 40 but may be more toward a center of the rotary cutting drum 32, but still off-center, as in the first load bearing structure 40 of FIG. 1B. Moreover, in some embodiments, the first load bearing structure 40 may include a plurality of smaller load-bearing substructures 44 arranged, for example, spaced apart from each other, as illustrated in the first load bearing structure 40 having first and second load-bearing substructures 44 illustrated in FIG. 1C. Embodiments are not limited to only two load-bearing substructures 44, and more load-bearing substructures 44 may be applied, including load-bearing substructures 44 of different widths (in the direction of the first axis of rotation 36). Load-bearing substructures 44 can be used in or substituted for any of the first load bearing structure 40 disclosed herein.

The anvil 50 includes an anvil portion 52 having an anvil surface 54 configured to directly contact the at least one knife member 42 and a second axis of rotation 56, a second axle 58 located coincident to the second axis of rotation 56, and a second load bearing structure 60 located on only one of a first end and a second end of the anvil portion 52. A first plurality of bearings 70 support the first axle 38 for rotation about the first axis of rotation 36, and a second plurality of bearings 72 support the second axle 58 for rotation about the second axis of rotation 56. A surface of the first load bearing structure 40 contacts a surface of the second load bearing structure 60.

With further reference to FIGS. 1A-2B, along the first axis of rotation 36, a first portion of the first axle 38 may be on one side of the rotary cutting drum 32, and a second portion of the first axle 38 may be on a second side of the rotary cutting drum 32. The first plurality of bearings 70 may include two rotary cutter bearings, including a first rotary cutter bearing configured to support the first portion of the first axle 38 for rotation about the first axis of rotation 36, and a second rotary cutter bearing configured to support the second portion of the first axle 38 for rotation about the first axis 36. Along the second axis of rotation 56, the second axle 58 may be on one side of the anvil portion 52, and the second load bearing structure 60 may be spaced apart from anvil portion 52. The second plurality of bearings 72 may include two anvil bearings, each configured to support the second axle 58 for rotation about the second axis 56. Along the second axis of rotation 56, a first of the two anvil bearings may be between the second load bearing structure 60 and the anvil portion 52, and the second load bearing structure 60 may be between the first of the two anvil bearings and a second of the two anvil bearings. The rotary cutting unit 1, 2, 3, 10, 100 may include a first pneumatic cylinder 80 configured to apply a first load to the second plurality of bearings. Although described herein as “pneumatic cylinders,” hydraulic cylinders can be used in conjunction with pneumatic cylinders (e.g., some cylinders are pneumatic and others are hydraulic), or hydraulic cylinders can be used in substitution for pneumatic cylinders.

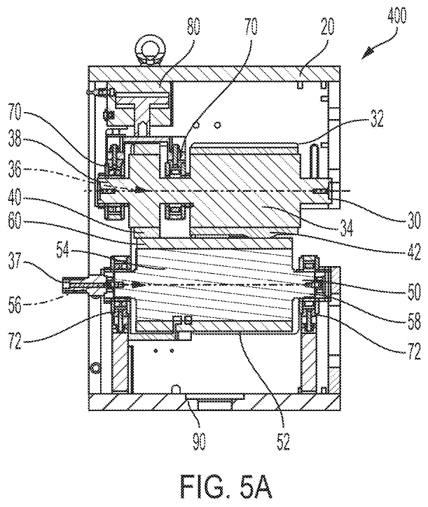

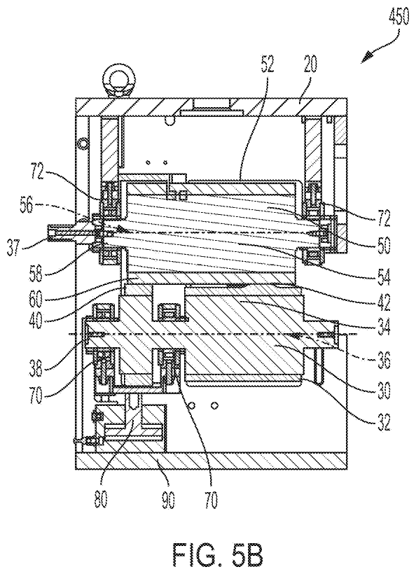

The rotary cutter 30 may be coupled to a motor 37 to be driven in rotation about the first axis of rotation. In this case, only the first axle 38, among the first and second axles 38, 58, may be directly supported by the frame 20. Alternatively, the anvil 50 may be coupled to a motor 37 to be driven in rotation about the second axis of rotation. In this case, only the second axle 58, among the first and second axles 38, 58, may be directly supported by the frame 20 (see FIG. 5A).

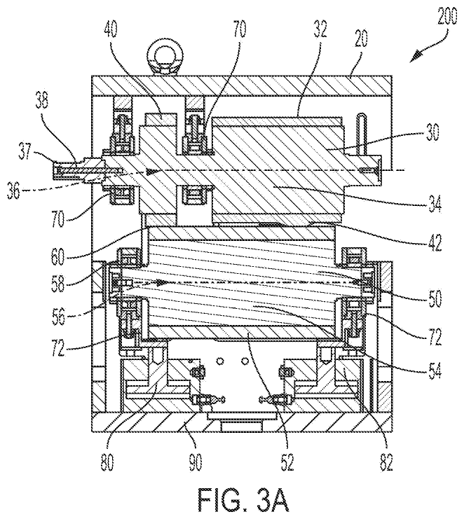

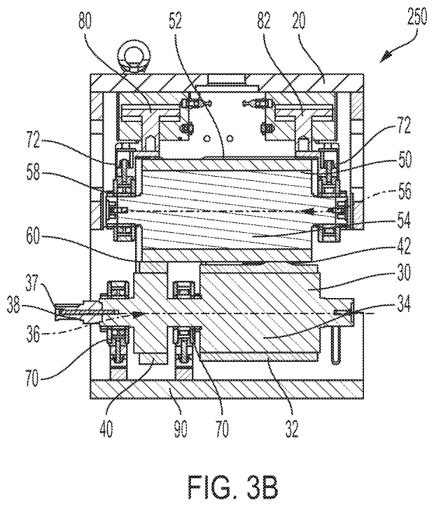

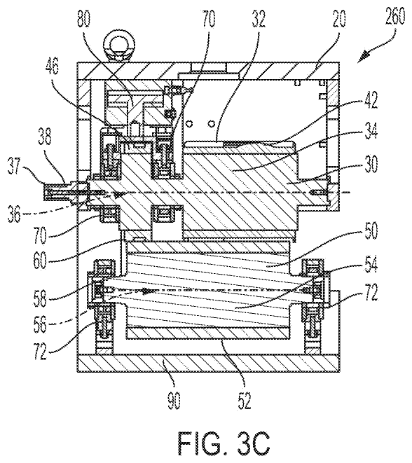

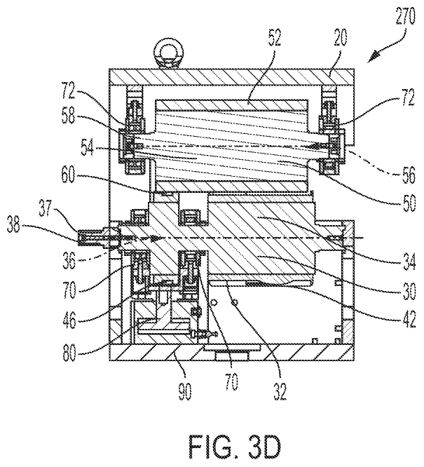

With reference to FIGS. 3A-5, in the respective embodiments of the rotary cutting unit 200, 250, 260, 270, 300, 350, 400, 450, along the first axis of rotation 36, the first axle 38 may be on one side of the rotary cutting drum 32, and the first load bearing structure 40 may be spaced apart from the rotary cutting drum 32. The first plurality of bearings 70 may include two rotary cutter bearings, each configured to support the first axle 38 for rotation about the first axis 36. Along the first axis of rotation 36, a first of the two rotary cutter bearings may be between the first load bearing structure 40 and the rotary cutting drum 32, and the first load bearing structure 40 may be between the first of the two rotary cutter bearings and a second of the two rotary cutter bearings. Along the second axis of rotation 56, a first portion of the second axle 58 may be on one side of the anvil portion 52, and a second portion of the second axle 58 may be on a second side of the anvil portion 52. The second plurality of bearings 72 may include two anvil bearings, including a first anvil bearing configured to support the first portion of the second axle 58 for rotation about the second axis of rotation 56, and a second anvil bearing configured to support the second portion of the second axle 58 for rotation about the second axis 56. The second load bearing structure 60 may be integral to the anvil surface 54.

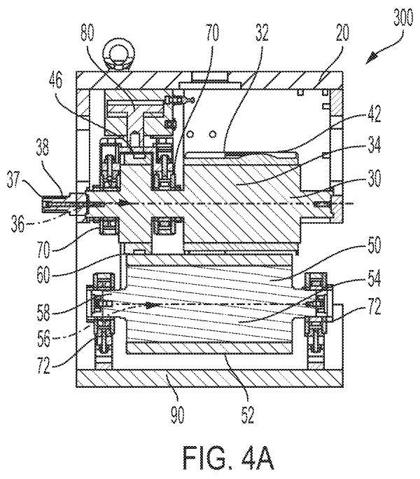

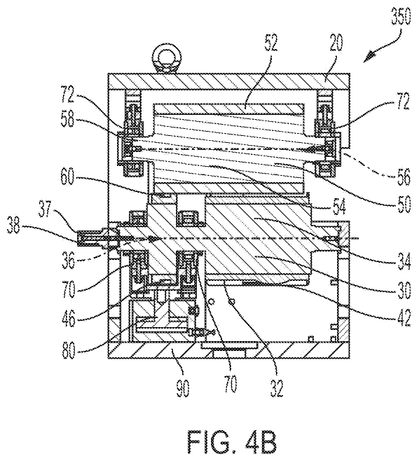

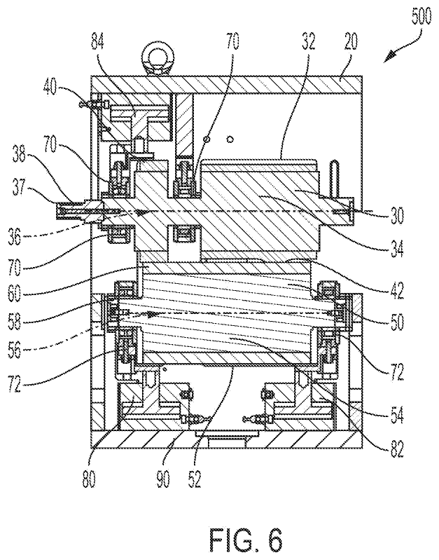

The rotary cutting units can include one or more pneumatic cylinders configured to apply a load to one or more bearings. For example, the cutting unit can include a pneumatic cylinder associated with each bearing, or one pneumatic cylinder can be associated with more than one bearing, or a mixture of one-to-one and one-to-plural association of pneumatic cylinder to bearing can be used. Also, some bearings may have an associated pneumatic cylinder, while other bearings do not have an associated pneumatic cylinder. With reference to FIGS. 3A-3B, the rotary cutting unit 200, 250 may further include a first pneumatic cylinder 80 configured to apply a first load to one of the second plurality of bearings 72. With reference to FIGS. 3A, 3B, and 6, the rotary cutting unit 500 may further include a second pneumatic cylinder 82 configured to apply a second load to a different one of the second plurality of bearings 72. With reference to FIGS. 4A-5B, the rotary cutting unit 300, 350, 400, 450 may further include a first pneumatic cylinder 80 configured to apply a first load to the first plurality of bearings 70. In some embodiments, the rotary cutting unit may include a further pneumatic cylinder configured to apply a further load to one of the bearings that does not already have a first pneumatic cylinder or a second pneumatic cylinder already associated with it, e.g., see rotary cutting unit 500 in FIG. 6, which has a further pneumatic cylinder 84 configured to apply a further load to one of the first plurality of bearings 70 of the rotary cutter 30.

With reference to FIGS. 3A-3D, 4A-4B, and 6, in the rotary cutting unit 200, 250, 260, 270, 300, 350, 500, the rotary cutter 30 may be coupled to a motor 37 to be driven in rotation about the first axis of rotation 56. In this case, only the first axle 38, among the first and second axles 38, 58, may be directly supported by the frame 20. With reference to FIGS. 5A-56, in the rotary cutting unit 400, 450, the anvil 50 may be coupled to a motor 37 to be driven in rotation about the second axis of rotation 56. In this case, only the second axle 58, among the first and second axles 38, 58, may be directly supported by the frame 20. The axle 56, 58 being driven is interchangeable, as would be understood by one of ordinary skill in the art.

With reference to FIGS. 1A-1C, 2A, 3A, 3C, 4A, 5A, and 6, the rotary cutter 30 may be horizontally above the anvil 50. With reference to FIGS. 1B, 2B, 3B, 3D, 4B, and 5B the anvil 50 may be horizontally above the rotary cutter 30. The rotary cutting unit 500 of FIG. 6 may also be configured, such that the anvil 50 is horizontally above the rotary cutter 30. In the noted figures, the base 90 of the frame 20 of the rotary cutting unit is oriented toward the ground and, for example, is on the floor or a suitable platform, and the rotary cutter 30 or anvil 50 that is horizontally above is relative to the location of the base 90.

With reference to FIGS. 2A-2B, the first pneumatic cylinder 80 may apply a bending effect on the anvil 50 (“positive bias anvil” or “PBA”) along the second axis of rotation 56 by applying a load on both sides of the second load bearing structure 60 being pressed against the first load bearing structure 40. With reference to FIGS. 3A-3B, the bending effect may be applied to the rotary cutter 30 (“positive bias cutter” or “PBC”) along the first axis of rotation 36 by applying a load on both sides of the first load bearing structure 40 being pressed against the second load bearing structure 60. With reference to FIGS. 3C-3D, the same PBC effect on the rotary cutter 30 as shown in FIGS. 3A-3B can be applied to the first load bearing structure 40 with multiple load-bearing substructures. With reference to FIGS. 4A-4B, the PBC bending effect may be applied to the rotary cutter 30 (“positive bias cutter” or “PBC”) by the first pneumatic cylinder 80 applying a load on the first plurality of bearings 70 on the cutter side, which allows a lower cutting height than in the configuration of FIGS. 3A-3B, which shows first and second pneumatic cylinder 80 and 82 on the second plurality of bearings 70 on the anvil side. The configuration of FIGS. 4A-4B may also allow for translation and rotation of the first load bearing structure 40 on the rotary cutter 30. FIG. 5A has the second axle 58 of the anvil 50 being driven, as opposed to the configuration of FIG. 2B, which has the first axle 56 of the rotary cutter 30 being driven. FIG. 5B has the second axle 58 of the anvil 50 being driven, as opposed to the configuration of FIG. 2A, which has the first axle 56 of the rotary cutter 30 being driven. FIG. 6 has the PBC effect on the rotary cutter 30 as in FIG. 3A, but the third pneumatic cylinder 84 provides additional control over the amount of the bending effect.

FIG. 2B is a similar arrangement to that of FIG. 2A, but with the positions of the rotary cutter 30 and the anvil switched, such that the rotary cutter 30 is arranged below the anvil 50 in a vertical direction. FIG. 3B is a similar arrangement to that of FIG. 3A, but with the positions of the rotary cutter 30 and the anvil 50 switched, such that the rotary cutter 30 is arranged below the anvil 50 in the vertical direction. FIG. 3D is a similar arrangement to that of FIG. 3C, but with the positions of the rotary cutter 30 and the anvil 50 switched, such that the rotary cutter 30 is arranged below the anvil 50 in the vertical direction. FIG. 4B is a similar arrangement to that of FIG. 4A, but with the positions of the rotary cutter 30 and the anvil 50 switched, such that the rotary cutter 30 is arranged below the anvil 50 in the vertical direction. FIG. 51 is a similar arrangement to that of FIG. 5A, but with the positions of the rotary cutter 30 and the anvil 50 switched, such that the rotary cutter 30 is arranged below the anvil 50 in the vertical direction.

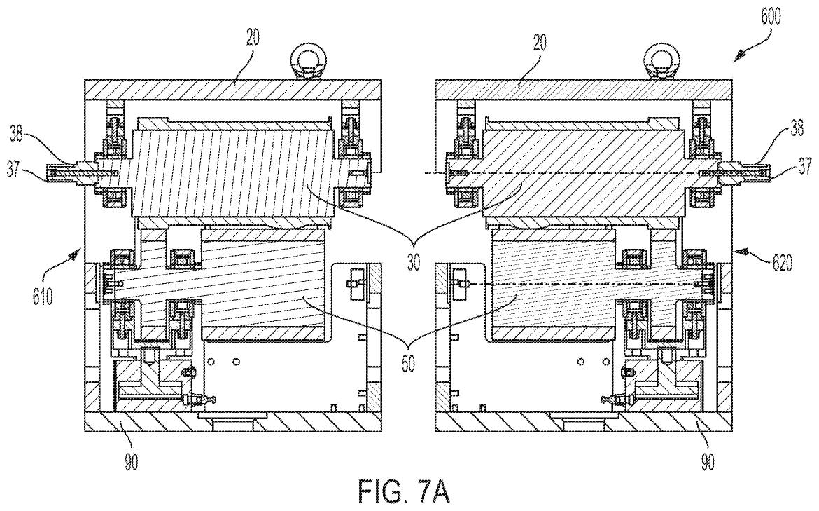

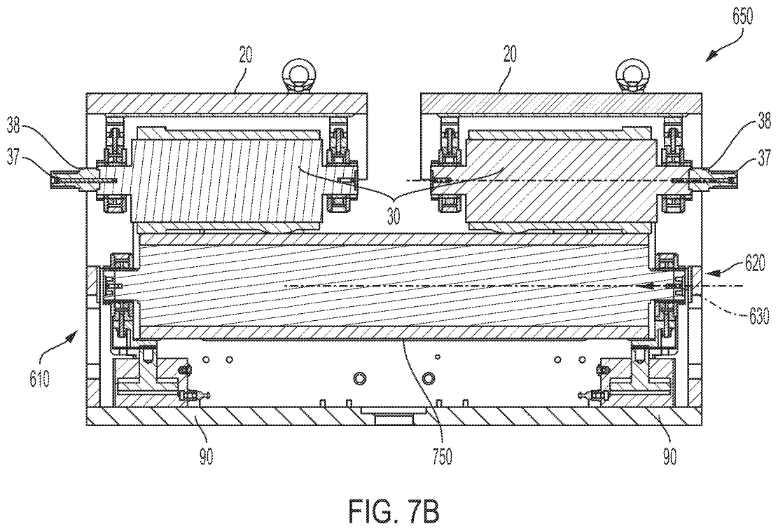

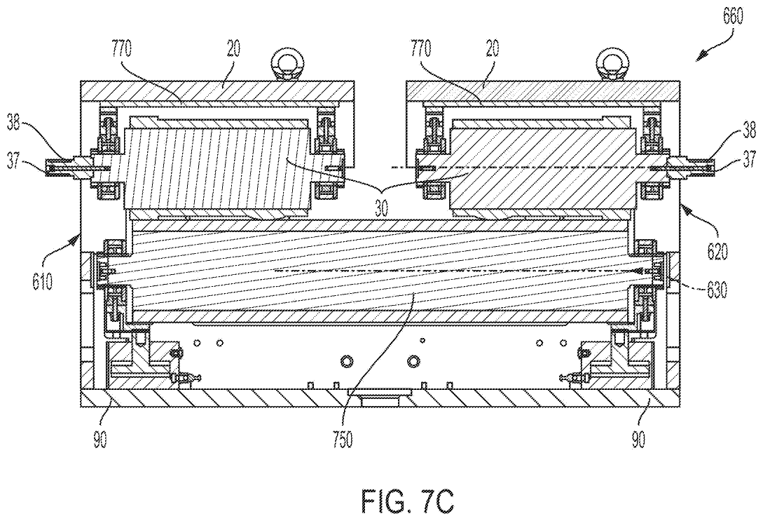

More than one rotary cutting unit can be combined to operate as a rotary cutting system. For example, a rotary cutting system can include a first rotary cutting unit and a second rotary cutting unit. The first and second rotary cutting units can be positioned, so that the open-sided arrangement of the first rotary cutting unit is oriented toward the open-sided arrangement of the second rotary cutting unit. In a rotary cutting system having such an arrangement, a first portion of material, such as a first edge region of the material, can be fed through the first rotary cutting unit between the rotary cutter and the anvil to be acted upon by the knife member to cut, and a second portion of material, such as a second edge region of the material, can simultaneously be fed through the second rotary cutting unit between the rotary cutter and the anvil to be acted upon by the knife member to cut. The open-sided arrangement of the first rotary cutting unit and second rotary cutting unit provides a space through which the material can travel in the feed direction, while the first and second end regions of the material are worked by the respective rotary cutting units. FIGS. 7A-7C schematically illustrate examples of rotary cutting systems, in which FIG. 7A is a side view of a rotary cutting system in accordance with an exemplary embodiment, FIG. 7B is a side view of a rotary cutting system in accordance with another exemplary embodiment, and FIG. 7C is a side view of a rotary cutting system in accordance with still another exemplary embodiment.

With reference to FIGS. 7A-7C, a rotary cutting system 600, 650, 660 may include a plurality of the rotary cutting units 1, 2, 3, 10, 100, 200, 250, 260, 270, 300, 350, 400, 450, 500 described above with reference to FIGS. 1A-6. A first rotary cutting unit 610 of the plurality of rotary cutting units is positioned relative to a second rotary cutting unit 620 of the plurality of rotary cutting units, so that the first axle 38 of the rotary cutter 30 of the first rotary cutting unit 610 is co-axial to the first axle 38 of the rotary cutter 30 of the second rotary cutting unit 620. In alternative embodiments, the first axle 38 of the rotary cutter 30 of the first rotary cutting unit 610 may be parallel and even offset from the first axle 38 of the rotary cutter 30 of the second rotary cutting unit 620. With reference to FIG. 7A, in the rotary cutting system 600, a distance separating the first rotary cutting unit 610 from the second rotary cutting unit 620 may be adjustable, such as by sliding. With reference to FIG. 75, in the rotary cutting system 650, the anvil 50 of the first rotary cutting unit 610 is integrated with the anvil 50 of the second rotary cutting unit 620, thus providing a single integrated anvil unit 750 across the first and second rotary cutting units 610, 620. The integrated anvil 750 of FIG. 7B causes the distance between the first and second rotary cutting units 610, 620 to not be adjustable, in contrast to the configuration of FIG. 7A. With reference to FIG. 7C, in the rotary cutting system 660, the anvil 50 of the first rotary cutting unit 610 is integrated with the anvil 50 of the second rotary cutting unit 620, such that an integrated anvil 750 is provided. In contrast to the configuration of FIG. 7B, the rotary cutter 30 of each of the first and second rotary cutting units 610, 620 hangs from the frame 20 on rails 770, which allow for a distance separating the first rotary cutting unit 610 from the second rotary cutting unit 620 to be adjustable, such as by sliding.

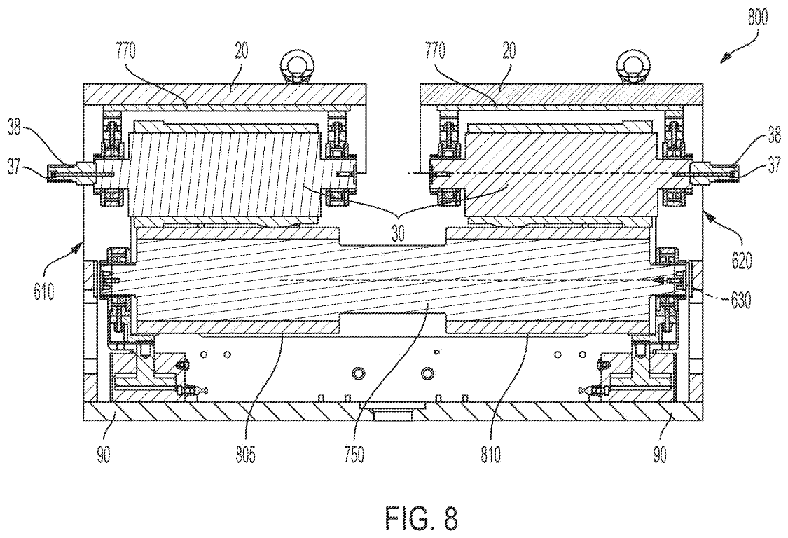

In some embodiments, the integrated anvil 750 has one continuous anvil surface rotating relative to a single axis of rotation 630. FIGS. 7B and 7C illustrate an example of an integrated anvil with only one continuous anvil surface. In other embodiments, the integrated anvil has a discontinuous anvil surface rotating relative to a single axis of rotation 630, such as having a first anvil surface associated with the rotary cutter of the first rotary cutting unit 610 and a second anvil surface associated with the rotary cutter of the second rotary cutting unit 620. FIG. 8 illustrates an embodiment of a rotary cutting system 800 similar to that in FIG. 7C and including an example of an integrated anvil 750 with a discontinuous anvil surface in the form of a first anvil surface 805 and a second anvil surface 810.

Although the present disclosure has been described in connection with embodiments thereof, it will be appreciated by those skilled in the art that additions, deletions, modifications, and substitutions not specifically described may be made without departure from the spirit and scope of the disclosure as defined in the appended claims.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated”, such that the desired functionality is achieved. Hence, any two components herein combined to achieve a particular functionality can be seen as “associated with” each other, such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

The illustrative embodiments described in the detailed description, drawings, and claims are not meant to be limiting. Other embodiments may be utilized, and other changes may be made, without departing from the spirit or scope of the subject matter presented here.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. The upper and lower limits of these smaller ranges which can independently be included in the smaller ranges is also encompassed within the disclosure, subject to any specifically excluded limit in the stated range. Where the stated range includes one or both of the limits, ranges excluding either both of those included limits are also included in the disclosure.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

Additionally, for example any sequence(s) and/or temporal order of sequence of the system and method that are described herein this disclosure are illustrative and should not be interpreted as being restrictive in nature. Accordingly, it should be understood that the process steps may be shown and described as being in a sequence or temporal order, but they are not necessarily limited to being carried out in any particular sequence or order. For example, the steps in such processes or methods generally may be carried out in various different sequences and orders, while still falling within the scope of the present disclosure.

Finally, the discussed application publications and/or patents herein are provided solely for their disclosure prior to the filing date of the described disclosure. Nothing herein should be construed as an admission that the described disclosure is not entitled to antedate such publication by virtue of prior disclosure.

1. A rotary cutting unit, comprising:
a frame;
a rotary cutter including:
a rotary cutting drum having a rotary cutting surface and a first axis of rotation,
a first axle located coincident to the first axis of rotation,
a first load bearing structure located on only one of a first end and a second end of the rotary cutting drum, and
at least one knife member located on the rotary cutting surface;
an anvil including:
an anvil portion having an anvil surface configured to directly contact the at least one knife member and a second axis of rotation,
a second axle located coincident to the second axis of rotation, and
a second load bearing structure located on only one of a first end and a second end of the anvil portion;
a first plurality of bearings supporting the first axle for rotation about the first axis of rotation; and
a second plurality of bearings supporting the second axle for rotation about the second axis of rotation,
wherein a surface of the first load bearing structure contacts a surface of the second load bearing structure.

2. The rotary cutting unit of claim 1, wherein, along the first axis of rotation:
a first portion of the first axle is on one side of the rotary cutting drum; and
a second portion of the first axle is on a second side of the rotary cutting drum.

3. The rotary cutting unit of claim 2, wherein the first plurality of bearings comprises two rotary cutter bearings including:
a first rotary cutter bearing configured to support the first portion of the first axle for rotation about the first axis of rotation; and
a second rotary cutter bearing configured to support the second portion of the first axle for rotation about the first axis.

4. The rotary cutting unit of claim 2, wherein, along the second axis of rotation:
the second axle is on one side of the anvil portion; and
the second load bearing structure is spaced apart from anvil portion.

5. The rotary cutting unit of claim 3, wherein:
the second plurality of bearings includes two anvil bearings, each configured to support the second axle for rotation about the second axis; and
along the second axis of rotation:
a first of the two anvil bearings is between the second load bearing structure and the anvil portion; and
the second load bearing structure is between the first of the two anvil bearings and a second of the two anvil bearings.

6. The rotary cutting unit of claim 5, further comprising a first pneumatic cylinder configured to apply a first load to the second plurality of bearings.

7. The rotary cutting unit of claim 1, wherein the rotary cutter is coupled to a motor to be driven in rotation about the first axis of rotation.

8. The rotary cutting unit of claim 7, wherein only the first axle, among the first and second axles, is directly supported by the frame.

9. The rotary cutting unit of claim 1, wherein the anvil is coupled to a motor to be driven in rotation about the second axis of rotation.

10. The rotary cutting unit of claim 9, wherein only the second axle, among the first and second axles, is directly supported by the frame.

11. The rotary cutting unit of claim 1, wherein, along the first axis of rotation:
the first axle is on one side of the rotary cutting drum; and
the first load bearing structure is spaced apart from the rotary cutting drum.

12. The rotary cutting unit of claim 11, wherein:
the first plurality of bearings includes two rotary cutter bearings, each configured to support the first axle for rotation about the first axis; and
along the first axis of rotation:
a first of the two rotary cutter bearings is between the first load bearing structure and the rotary cutting drum; and
the first load bearing structure is between the first of the two rotary cutter bearings and a second of the two rotary cutter bearings.

13. The rotary cutting unit of claim 11, wherein, along the second axis of rotation:
a first portion of the second axle is on one side of the anvil portion; and
a second portion of the second axle is on a second side of the anvil portion.

14. The rotary cutting unit of claim 13, wherein the second plurality of bearings comprises two anvil bearings including:
a first anvil bearing configured to support the first portion of the second axle for rotation about the second axis of rotation; and
a second anvil bearing configured to support the second portion of the second axle for rotation about the second axis.

15. The rotary cutting unit of claim 12, further comprising a first pneumatic cylinder configured to apply a first load to the second plurality of bearings.

16. The rotary cutting unit of claim 15, further comprising a second pneumatic cylinder configured to apply a second load to the first plurality of bearings.

17. The rotary cutting unit of claim 11, further comprising a first pneumatic cylinder configured to apply a first load to the first plurality of bearings.

18. The rotary cutting unit of claim 11, wherein the rotary cutter is coupled to a motor to be driven in rotation about the first axis of rotation.

19. The rotary cutting unit of claim 18, wherein only the first axle, among the first and second axles, is directly supported by the frame.

20. The rotary cutting unit of claim 11, wherein the anvil is coupled to a motor to be driven in rotation about the second axis of rotation.

21. The rotary cutting unit of claim 20, wherein only the second axle, among the first and second axles, is directly supported by the frame.

22. The rotary cutting unit of claim 1, wherein the rotary cutter is horizontally above the anvil.

23. The rotary cutting unit of claim 1, wherein the anvil is horizontally above the rotary cutter.

24. The rotary cutting unit of claim 1, wherein the first load bearing structure is at a far side of the rotary cutting drum.

25. The rotary cutting unit of claim 1, wherein the first load bearing structure is off-center of the rotary cutting drum.

26. The rotary cutting unit of claim 1, wherein the first load bearing structure comprises a plurality of adjacent load-bearing substructures.

27. The rotary cutting unit of claim 1, wherein a bending effect is applied to one of the rotary cutter or the anvil.

28. A rotary cutting system, comprising a plurality of rotary cutting units, each of the plurality of rotary cutting units comprising the rotary cutting unit of claim 1.

29. The rotary cutting system of claim 28, wherein a first rotary cutting unit of the plurality of rotary cutting units is positioned relative to a second rotary cutting unit of the plurality of rotary cutting units, so that the first axle of the rotary cutter of the first rotary cutting unit is co-axial to the first axle of the rotary cutter of the second rotary cutting unit.

30. The rotary cutting system of claim 29, wherein the first axle of the rotary cutter of the first rotary cutting unit being co-axial to the first axle of the rotary cutter of the second rotary cutting unit forms an integrated axle across the first rotary cutting unit and the second rotary cutting unit.

31. The rotary cutting system of claim 30, wherein an integrated anvil has a continuous anvil surface rotating relative to a single axis of rotation.

32. The rotary cutting system of claim 30, wherein an integrated anvil has a discontinuous anvil surface rotating relative to a single axis of rotation, the discontinuous anvil surface comprising:
a first anvil surface associated with the rotary cutter of the first rotary cutting unit; and
a second anvil surface associated with the rotary cutter of the second rotary cutting unit.

33. The rotary cutting system of claim 29, wherein a distance separating the first rotary cutting unit from the second rotary cutting unit is adjustable by sliding.

34. The rotary cutting system of claim 29, wherein the anvil of the first rotary cutting unit is integrated with the anvil of the second rotary cutting unit.

35. The rotary cutting system of claim 34, wherein the rotary cutter of each of the first rotary cutting unit and the second rotary cutting unit is fixed to the frame of its respective rotary cutting unit.

36. The rotary cutting system of claim 34, wherein the rotary cutter of each of the first rotary cutting unit and the second rotary cutting unit is attached to a respective rail on each respective frame of its rotary cutting unit, such that a distance separating the first rotary cutting unit from the second rotary cutting unit is adjustable by sliding.
